(19) United States
(12) Patent Application Publication
(10) Pub. No.: US 2007/0195752 A1
(43) Pub. Date: Aug. 23, 2007

(54) System and method for handling call redirection and multi call destination failures

(75) Inventors: Ruth Schaefer Gayde, Naperville, IL (US); Suzann Hua, Lisle, IL (US); Todd Cartwright Morgan, Oak Park, IL (US); John Richard Rosenberg, Elmhurst, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/359,061

(22) Filed: Feb. 22, 2006

(51) Int. Cl. H04J 3/14; H04L 12/66; H04J 1/16

(52) U.S. Cl. 370/352; 370/216

(57) ABSTRACT

A system and method for providing Call Forwarding/Multi-Destination Call Redirection services that include notifying the subscriber/owner of a call leg creation failure and taking corrective action to prevent future failures. The failure can be detected at a Far End network node and communicated to a Detection node which communicates with a Resolver node for taking corrective action.

### BACKGROUND OF THE INVENTION

This invention relates to a system and method for providing call redirection and/or multi call destination services and more particularly to a system and method for providing suitable actions based on call leg creation failures occurring during these service operations.

While the invention is particularly directed to the art of telecommunications networks including wireless and wireline networks as well as packet data networks, and will be thus described with specific reference thereto, it will be appreciated that the invention may have usefulness in other fields and applications including .

Today, when a user registers a number for call forwarding, also known as call redirection, or as part of a multi destination call with the network, such as a registration of a Call Forwarding Forward-To Number (FTN), the network may not validate whether the number used for the redirection is a valid destination. If the number used for redirection turns out to be bad, such as a disconnected number, there is no automated mechanism to correct the problem to prevent further occurrences. There is also no automated mechanism to notify the served user, that is the user who registered the bad number, of the error. Consequently, this problem will persist for this user until perhaps he is notified by a person who has tried unsuccessfully to communicate with him in this manner.

The context for bad numbers for call redirection and/or multi call destination calls includes not only call forwarding, but also such services as Flexible Alerting, Simultaneous Ringing, Multi-Line Hunt Group, Sequential Ringing, and Series Completion Service. For all of these services, the served user may provision one or more destination numbers and is not involved at invocation time and thus cannot receive immediate notification when a destination number is bad.

The present invention contemplates a new and improved system and method that resolves the above-referenced difficulties and others.

### SUMMARY OF THE INVENTION

A system and method for providing Call Redirection and/or Multi Call Destination services that can include performing a corrective Action and/or notifying the subscriber/owner of a call leg creation failure and providing them further information which can include the reason for the failure.

In one aspect of the invention, the method includes determining that a Call Redirection/Multi Call Destination (CR/MCD) call leg for a subscriber cannot be established at a Far End switch, sending one or more messages from the Far End Switch to a Detector indicating that the CR/MCD call leg cannot be established and the reason the CR/MCD cannot be established, and performing an Action based on the failure to establish the CR/MCD call leg.

In another aspect of the invention the system includes a Far End switch including means for determining that a CR/MCD call leg for a subscriber cannot be established and means for communicating with a Network Element that the CR/MCD call leg cannot be established and the reason the CR/MCD call leg cannot be established, a Detector located remotely from the Far End Switch including means for communicating with the Far End switch to determine that the CR/MCD call leg cannot be established and the reason that the CR/MCD call leg cannot be established and means for notifying a network element that a CR/MCD call leg for the subscriber cannot be established, and a Resolving Network Element including means for communicating with the Detector for determining that CR/MCD call leg cannot be established and the reason that the CR/MCD call leg cannot be established and means for performing an Action based on the failure to establish the CR/MCD call leg.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a system for handling call redirection/multi call destination (CR/MCD) failures in accordance with the invention;

FIG. 2 is a flow chart illustrating a method for handling call redirection/multi call destination (CR/MCD) failures in accordance with the invention;

FIG. 3 is a block diagram illustrating an example of a CDMA system for handling Call Redirection failures in accordance with the invention;

FIG. 4 is a call flow diagram illustrating the messaging provided by the system illustrated in FIG. 3 for Call Redirection;

FIG. 5 is a call flow diagram illustrating the messaging provided by the system illustrated in FIG. 3 for Flexible Alerting;

FIG. 6 is a block diagram illustrating an example of an IMS system for handling Call Redirection failures in accordance with the invention; and

FIG. 7 is a call flow diagram illustrating the messaging provided by the system illustrated in FIG. 3 for Call Redirection.

### DETAILED DESCRIPTION OF THE PREFERRED EMBODIMENTS

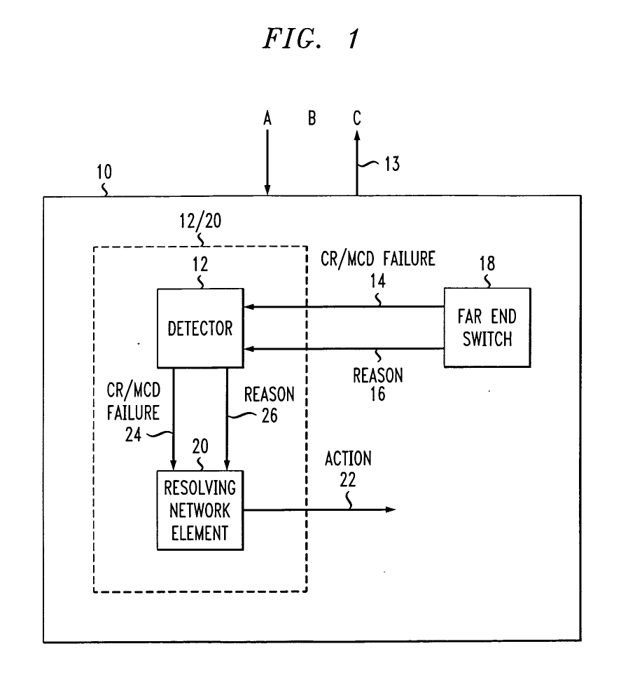

Referring now to the drawings wherein the showings are for purposes of illustrating the preferred embodiments of the invention only and not for purposes of limiting same. In FIG. 1, a system shown generally at 10, for performing Call Redirection and/or Multi Call Destination (CR/MCD) call services in a communications network for voice calls made by a calling party A to a called party B which are forwarded or redirected to one or more parties C, D, E, etc. CR/MCD calls as pertaining the invention described herein, can include services including, but are not limited to, call forwarding, call redirection, flexible alerting, simultaneous ringing, and multi-line hunt groups, among others.

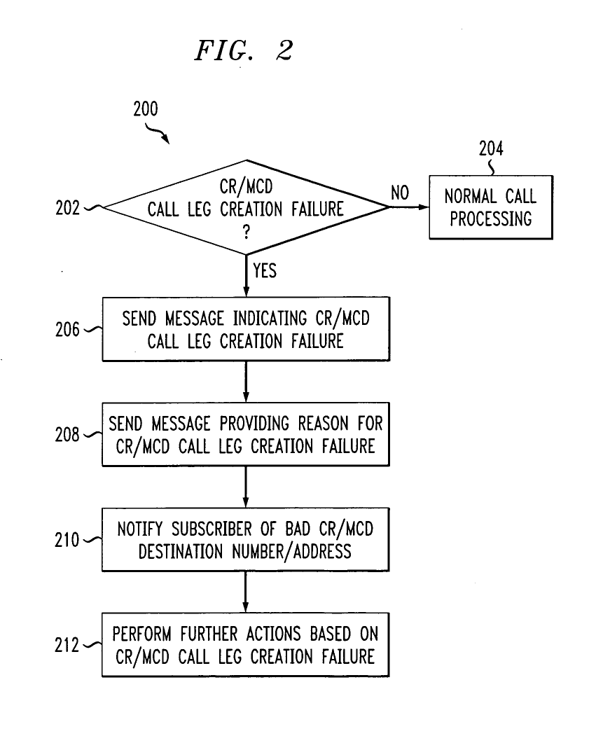

For the examples provided herein, party B, for which calls are being forwarded or redirected, can be referred to as a subscriber, such as a subscriber to the CR/MCD services described herein, or the owner of such data that may be required to perform these services. The system 10 includes network elements of suitable construction using suitable protocols so as to be applicable to cellular telecommunications networks, landline telecommunications networks, circuit switched communications networks, packet-based communications networks, Internet Protocol (IP) communications networks such as those suitable for Voice Over Internet Protocol (VOIP) calls, and Internet Protocol Multimedia Subsystem (IMS) communications networks. FIG. 2 illustrates the general method of operation, as shown generally at 200, of the system 10 described herein.

The system 10 includes a Detector 12 for detecting a failure in the establishment of a CR/MCD call leg 13, also referred to as a CR/MCD call leg creation failure, during a CR/MCD operation as shown at step 202. If this failure is not detected, normal call processing occurs at 204. An example of a CR/MCD call leg includes the call leg to the forwarded or redirected destination, as represented herein by C. C can be a phone, landline or mobile terminal, or other apparatus for receiving calls such as a VOIP capable device, etc. The Detector 12 can also determine the reason for the failure, such as for example, the forwarded/redirected destination number is out of service or disconnected, or this number has been changed, or the CR/MCD information includes a vacant code or unassigned number, etc. The Detector 12 can be a switch, a Mobile Switching Center (MSC), an Application Server (AS), or some combination thereof, among others.

The system 10 can also include a Far End Switch 18 responsible for establishing the CR/MCD call leg 13 to the forwarded/redirected destination, C in most of the examples provided herein. The Far End Switch 18 typically establishes the CR/MCD call leg to a local destination, or a destination assigned to the switch, such as C's phone.

The Far End Switch 18 includes means for determining that the CR/MCD call leg 13 cannot be established, that is to say that the CR/MCD call leg creation has failed. The Far End Switch 18 also includes means for communicating to the Detector 12 at 14 that the CR/MCD call leg cannot be established as shown at step 206. The Far End Switch 18, can also include means for communicating to the Detector 12 at 16 the cause or the reason that the CR/MCD call leg cannot be established as shown at step 208. These communications 14 and 16 can be provided using SIP or ISUP signaling, or other known protocols employing new commands or fields, etc. for providing this information. It should be appreciated that the separate messages shown at 206 and 208 can be a single message.

The Detector 12 includes means for determining that the CR/MCD call leg 13 cannot be established, that is that CR/MCD call leg creation failed, which can include means for communicating with the Far End Switch 18 for receiving this information. The Detector 12 can also include means for determining the reason that the CR/MCD call leg creation failed, which can include means for communicating with the Far End Switch 18 for receiving this information provided as described above.

The system 10 also includes a Resolving Network Element (RNE) 20 having means for performing one or more Actions, shown generally at 22, based on the failure to establish the CR/MCD call leg. As described in further detail in the examples provided herein, the Action 22 can include notifying the subscriber of the failure to establish the CR/MCD call leg and the reason for the failure as shown at step 210. The notification can include sending a message over one or more media to the subscriber B, also referred to as the owner B, to alert them of the redirection error. One example of such as message can include sending an SMS message and/or email informing B that their CR/MCD number, that is the number used to redirect their calls to C, is bad. Other examples of notifications include sending a SIP MESSAGE directly to a SIP-enabled user entity (device), leaving a message in a voice mail, sending an instant message, sending notification to web portal or other set of application servers.

The Action 22 performed by the RNE 20 based on the failure to establish the CR/MCD call leg can also include deactivating the bad CR/MCD number to cease initiating future CR/MCD call legs to the affected destination as shown at 212. The Action 22 can take place after one CR/MCD call leg failure or after reaching a threshold including a predetermined number of failures to the same destination, that of C in the examples provided. The RNE 20 can be a Home Location Register (HLR) in a wireless telecommunications network, a Service Control Point (SCP), an Application Server, or a Switch, such as a switch in a wireline telecommunications network.

It should be appreciated that the Detector 12 and RNE 20 can be the same network element as shown by the dashed line 12/20. Alternatively, the Detector 12 and RNE 20 can be different network elements, and if different elements, the system 10 also includes means for communicating between the Detector 12 and the RNE 20, for informing the RNE of the CR/MCD call leg creation failure as shown at 24 and means for communicating between the Detector and the RNE for providing the RNE information needed to take the Actions described herein as shown at 26. This information can include an identification of the subscriber B and the failed CR/MCD number, the number for reaching C, and the cause or reason for the failure.

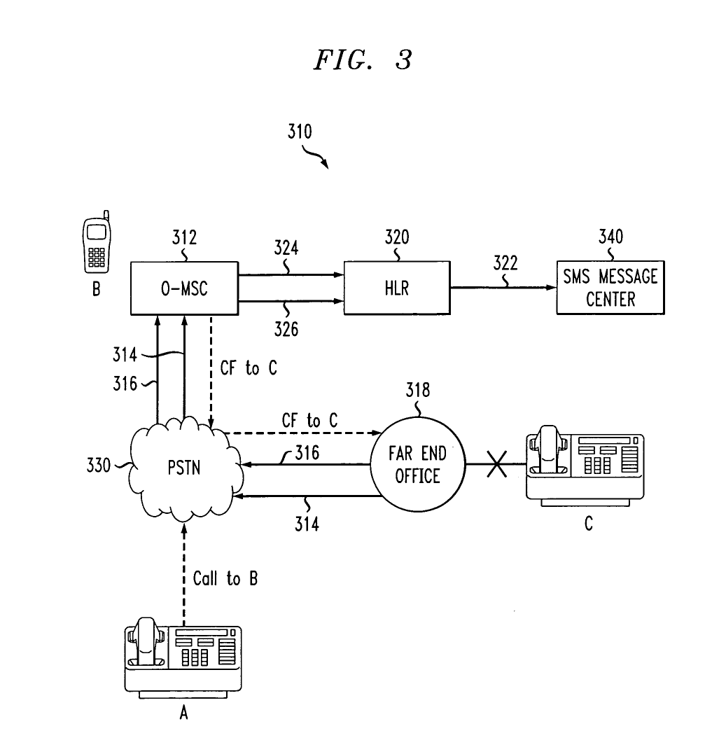

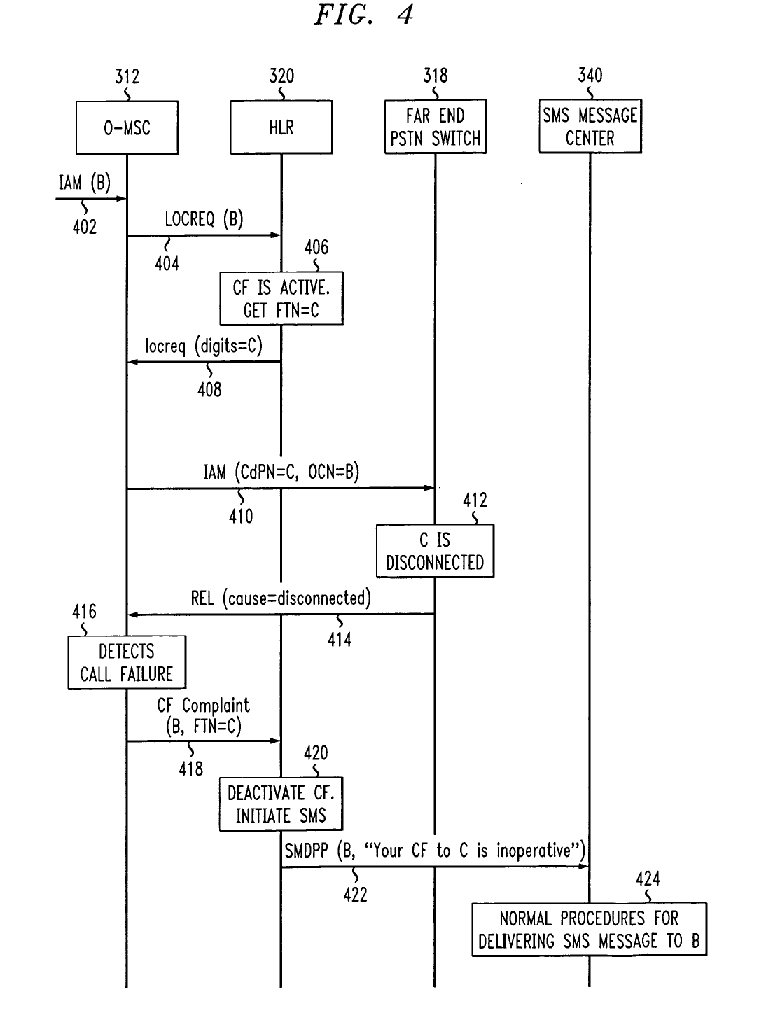

FIG. 3 shows an example of the system 10 described above, which is shown generally at 310, that includes CDMA wireless telecommunications network elements as part of a wireless network for performing Call Forwarding in accordance with the invention. FIG. 4 illustrates the call flow messaging sent between the network elements of FIG. 3 for this Call Forwarding example. In the example illustrated by FIGS. 3 and 4, calling party A calls called party B. Called party B subscribes to Call Forwarding, as provided by B's wireless telecommunications Service Provider, so that calls made to B's Directory Number are forwarded to C.

In the system 310 of this example, the Detector 12 includes an Originating Call Control Element (OCCE), and more specifically an Originating MSC (O-MSC) 312. The O-MSC 312 is responsible for routing CR/MCD calls made to the subscriber B to one or more other destinations, such as for example to C.

The system 310 also includes a Far End Switch 318 for establishing a CF call leg to C. The O-MSC 312 communicates with the Far End Switch 318 via the PSTN 330. The system 310 also includes B's HLR 320 functioning as the RNE 20. The system 310 also includes an SMS Message Center 340 for sending SMS messages to B as shall be described in further detail below.

The Originating MSC 312 receives the incoming call destined for B by receiving an Initial Address Message (IAM) identifying B as the destination for the call from the Public Switched Telephone Network (PSTN) at 402. In this example, the O-MSC 312 is B's Originating MSC which receives calls destined for B and is responsible for routing these incoming calls to B, including instances where B is roaming.

The O-MSC 312 attempts to route the call to B by sending a Location Request Invoke (LOCREQ) message to B's HLR at 404. The LOCREQ message identifies B, such as by B's DN or in some other manner, as the called party to which the call is to be routed to.

B's HLR 320 determines that calls made to B are to be unconditionally call forwarded to C at 406. As a result of this requirement, the HLR 320 retrieves a Call Forwarding Forward-to-Number (FTN) for C.

The HLR responds to the LOCREQ of 404 with a Location Request Return Result response (locreq) at 408 providing C's FTN address, such as C's phone number, to the O-MSC for forwarding the call to C.

The O-MSC 312 forwards the call to C at 410 by sending an IAM to the appropriate Far End Switch 318 responsible for setting up calls to C, as determined by locreq-response from 408. The IAM includes C's address as the Called Party Number and B's address as the Original Called Number (OCN).

As a result of C's number being recently disconnected, the Far End Switch 318 cannot route the call to C by establishing the call leg to C at 412, resulting in a CR/MCD call leg creation failure. Thus, the Far End Switch 318. informs the O-MSC 312 of this failure and the reason for this failure by sending a RELEASE (REL) message back to the O-MSC at 414 providing this information. The REL message can inherently indicate the CR/MCD call leg creation failure to the O-MSC 312. The REL message can provide the MSC with the reason for the call failure, that being C's number has been disconnected. Further, if the number used for forwarding/redirecting calls to C is changed to a new number, instead of being disconnected, the Far End Switch 318 can include the new number in the REL message or some similar message.

The O-MSC 312 receives the REL message 414 detecting the CR/MCD call leg creation failure and the reason for this failure as provided by the contents of the REL message at 416. The O-MSC 312 then informs the. HLR 320 by sending a Call Forward (CF) Complaint message at 418 indicating to the HLR that there has been a CR/MCD call leg creation failure. The CF Complaint message also includes B's number as the called party number and C's number as the FTN, and the reason for the CR/MCD call leg creation failure. If C's number was changed, the CF Complaint message can include the new number.

Because of the CF Complaint notification message of 418, the HLR 320 deactivates Call Forwarding for B to C at 420.

Further, upon receiving the CF Complaint notification message of 418, the HLR 320 notifies B that the CR/MCD destination number, C's number, being used as the FTN number, is not correct because it has been disconnected. As stated, this notification can be provided via a text message. The HLR 320 sends an SMS Message Delivery Point to Point (SMDPP) message to the SMS Message Center 340 at 422. The SMDPP message includes B's number as well as the text message to be set to B notifying B that B's call forwarding to destination C is inoperative. The message can also indicate the reason for this, such as C's number has been disconnected, etc. The text message is sent to B at 424. The message can also include C's new number if C's number was changed as opposed to being disconnected as described above.

The Call Redirection (Call Forwarding) example can include calls forwarded more than once, that is calls forwarded from B to C and then from C to D. In this example, C has also forwarded to D using MSC-2. If the call leg creation to D fails because D is a bad destination, then the failure detector for the C-to-D leg will notify C's HLR, in a manner similar to the message at 418 above, but not B's HLR. The ISUP REL message will propagate backward from MSC-2 to MSC-1. Any MSC-1 that has implemented the invention will also have the intelligence to recognize that this CR/MCD call leg creation failure occurred during multi-hop forwarding due to parameters in the signaling such as Original Called Number and Redirecting Number not being equal for the multi-hop case. Further, the MSC-1 also knows that the CR/MCD call leg creation failure happened only on the last CR/MCD leg using MSC-2. The reason for not propagating the CF deactivations and failure notifications all the way backward to the O-MSC reduces any confusion that would occur on B's part since B may not know that the call is being forwarded from C to D.

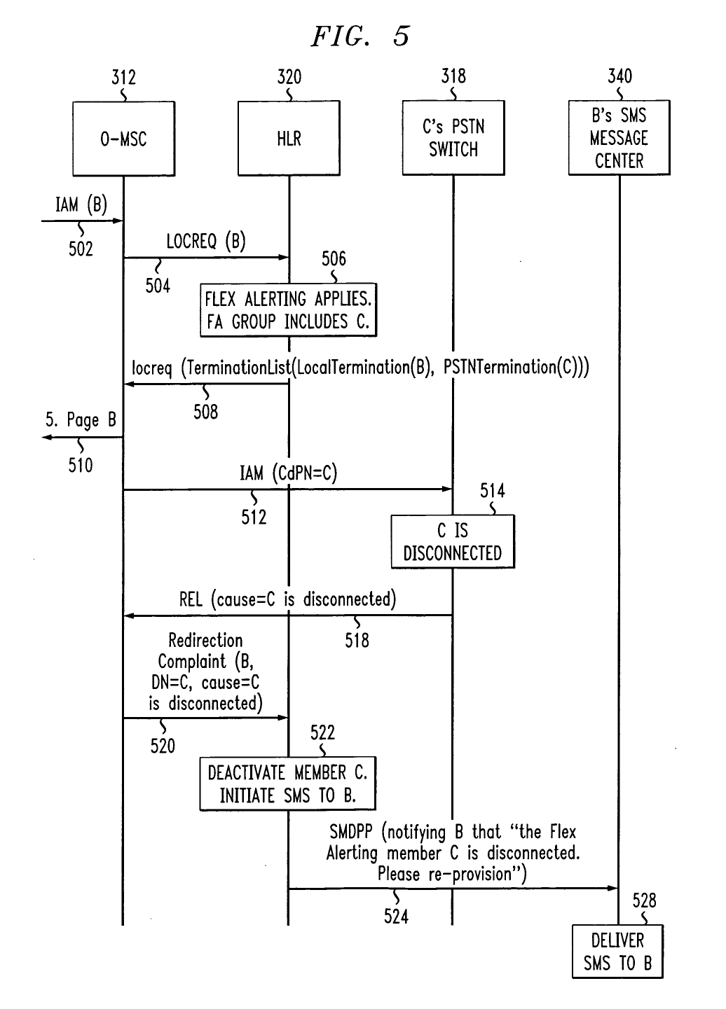

Referring now to FIG. 5, a call flow diagram is shown illustrating an example for a CDMA Flexible Alerting (FA) service in which a call leg creation failure occurs while establishing a CR/MCD call leg to a member of the FA group consisting of multiple call destinations. This failure can occur due to a bad destination being provided for that group member, such as may happen when the phone number for that member is disconnected, or in other known manners.

A calls the Flexible Alerting Pilot B. In this example, B is a mobile connected to the CDMA wireless network. The call arrives at B's home, or O-MSC 312 in the form of an ISUP IAM for B at 502. The O-MSC 312 sends a LOCREQ invoke message to the HLR for B at 504.

The HLR for B 320 determines that B is a pilot for a Flexible Alerting group, and retrieves information about the group members at 506.

The HLR 320 responds to the O-MSC by sending a locreq response at 508 that includes a Termination List including all of the call legs for this Flexible Alerting call. The Termination List in the locreq response includes 2 legs: one for a Local Termination for B, since B is registered within radio contact at the O-MSC 312 in this example, and the other one for a PSTN termination for C, another member of the Flexible Alerting group.

From parameters in the locreq response 508, the O-MSC 312 determines that this is a multi-leg call requiring it to set up call legs to both B and C. So the O-MSC 312 offers the call to B by sending a Page message to B at 510 to establish the call leg to B in a known manner.

The O-MSC 312 also sends an IAM for C to the PSTN at 512 which includes C's number as the called party number to offer the call to C.

At the Far End Switch responsible for connecting the call to C, the switch determines that C has been disconnected and that the call leg to C thus cannot be established at 512.

As a result, C's switch responds to the IAM of 512 with a REL message (a disconnect message) at 518. The REL message includes the cause of the CR/MCD call leg creation failure, indicating that C has been disconnected.

The O-MSC 312, which is still waiting for the disposition for all the call legs of this multi-leg call, gets the disconnect message at 518, and detects that this error needs to be reported to the HLR 320. The FA call continues with processing of the other FA call legs made to other member(s) of the group in a manner which is known in the art. The O-MSC 312 sends a Redirection Complaint to the HLR 318 at 520, including the fact that this is for the specific Flexible Alerting group owned by B, that the offending member DN is C, and that the cause for the complaint/failure is that C is disconnected.

The HLR 320 deactivates member C from this Flexible Alerting group at 522. The HLR 320 also notifies the owner of this FA group (B) that there is a bad member DN in the group at 522. The HLR 320 sends an SMS message to B's short message service center at 524 and B is notified of the error via known SMS messaging at 528 in a similar manner as described above.

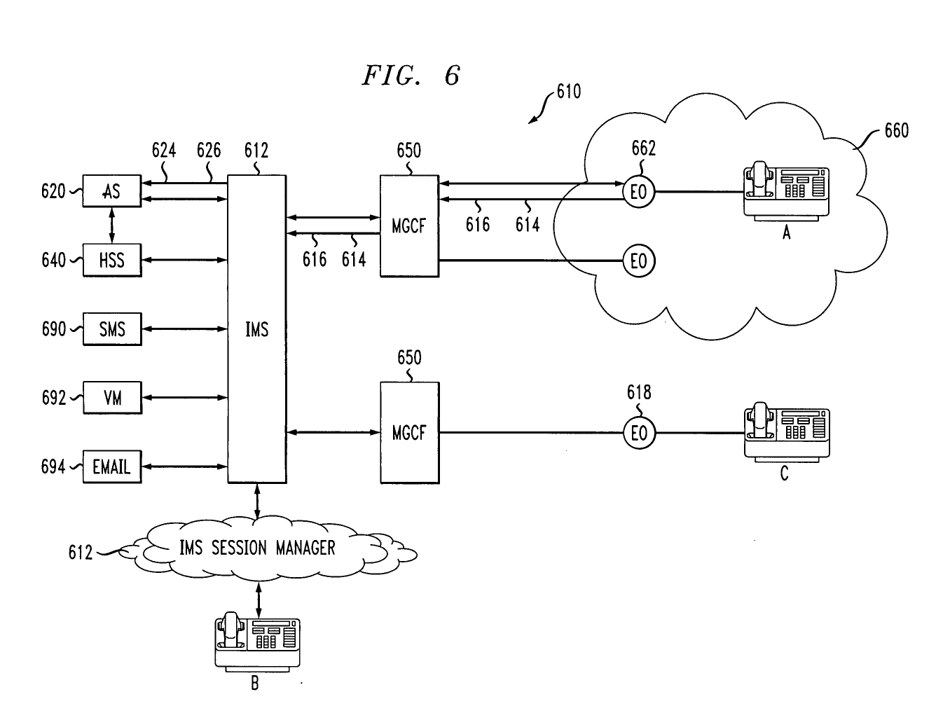

FIG. 6 shows an example of the system 10 described above, which is shown generally at 610, that includes an IMS communications network elements as part of a telecommunications network for performing Call Forwarding and/or Call Redirection in accordance with the invention. The system 610 includes an IMS Session Manager 612 functioning as the Detector 12 described above. An IMS based Application Server 620 functions as the RNE 20 described above. C's End Office (EO) 618 functions as the Far End Switch 18 described above. Also shown in FIG. 6 are Media Gateway Control Function (MGCF) elements 650 for providing the circuit trunk, such as those using ISUP signaling as shown at 660, to IP interfaces which are known in the art. A Home Subscriber Server (HSS) for B contains B's subscription information data including call forwarding indicators and addresses to the destinations the calls are to be forwarded to, such as C's address. Message Service function blocks are shown for SMS messaging at 690, Voice Mail messaging at 692, and E-mail messaging at 694.

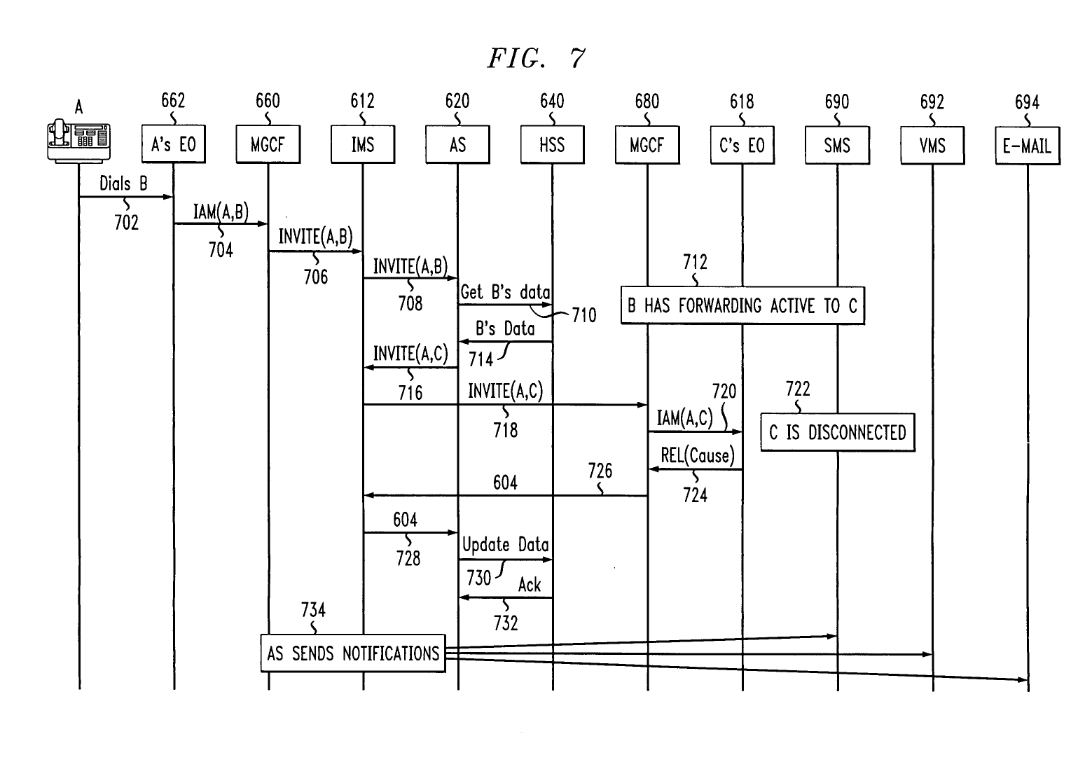

FIG. 7 illustrates the call flow messaging sent between the network elements of FIG. 6 for this Call Forwarding example. In the example illustrated by FIGS. 6 and 7, calling party A calls called party B. Called party B subscribes to Call Forwarding, as provided by B's telecommunications Service Provider, so that calls made to B's Directory Number are forwarded to C.

A calls B at 702 and A's EO 662 sends an ISUP IAM toward B's home IMS at 704. The MGCF 650 converts the IAM to a SIP INVITE message and sends it to the IMS Session Manager 612. The IMS Session Manager 612 relays the INVITE message to B's AS 620 at 708. The AS 620 queries the B's HSS-640 at 710 to get B's feature data indicating what subscription features B subscribes to which can affect the call. Since B currently has Call Forwarding active to C as determined at 712, the HSS 640 sends B's feature data to the AS 620 indicating such. The AS 620 notes that forwarding to C is active, adjusts the INVITE message accordingly by including C's address as well as A's address therein, and sends it back to the IMS Session Manager 612 at 716. The IMS 612 sends the INVITE toward the appropriate MGCF 650 at 718. The MGCF 650 converts the INVITE to an ISUP IAM and routes it toward C's EO 618 at 720.

The destination number for C has been recently been disconnected, and no additional info is available. C's EO 618 sends an ISUP RELease message backward, to the MGCF 650 which includes a Cause Code parameter indicating that C was disconnected, thereby providing the reason for the CR/MCD call leg creation failure. The ISUP REL message itself indicates that the CR/MCD call leg creation failure occurred.

The MGCF 650 converts the ISUP REL into a SIP 604 message and sends to the IMS Session Manager at 726. The IMS Session Manager 612 sends the 604 message to the AS 612 at 728. The AS updates B's CF data in the HSS 640 at 730 to deactivate call forwarding thereby functioning as the RNE 20 as described above.

The HSS 640 acknowledges the change at 732. The AS 620 sends notification to B at 734 that the forward-to number is bad via Short message Service (SMS), and/or e-mail, and/or voice mail, again functioning as the RNE 20 as described above.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of call control in a communications network comprising:
determining that a Call Redirection/Multi-Call Destination (CR/MCD) call leg for a subscriber cannot be established at a Far End Switch;
sending one or more messages from the Far End Switch to a Detector indicating that the CR/MCD call leg cannot be established and the reason the CR/MCD cannot be established; and
performing an Action based on the failure to establish the CR/MCD call leg.

2. The method defined in claim 1 wherein the communications network includes at least one of a circuit switched network, a packet network, a packet network, an Internet Protocol Multimedia Subsystem (IMS) network, and an Internet Protocol network.

3. The method defined in claim 1 wherein the Action includes notifying a subscriber/owner that a CR/MCD call leg cannot be established.

4. The method defined in claim 1 wherein the Action includes notifying a subscriber/owner of the reason that a CR/MCD call leg cannot be established.

5. The method defined in claim 1 wherein the Action includes notifying a subscriber/owner of a different destination number for establishing the failed CR/MCD call leg.

6. The method defined in claim 1 wherein the CR/MCD call leg is part of a Call Forwarding call operation.

7. The method defined in claim 1 wherein the CR/MCD call leg is part of a Simultaneous Ringing call operation.

8. The method defined in claim 1 wherein the CR/MCD call leg is part of a Multi-Line Hunt Group call operation.

9. The method defined in claim 1 wherein the CR/MCD call leg is part of a Flexible Alerting call operation and the step of performing an Action includes at least one of notifying the Flexible Alerting Pilot that the CR/MCD call leg cannot be established and notifying the Flexible Alerting Pilot of the reason that the CR/MCD call leg cannot be established.

10. The method defined in claim 1 wherein the Detector is an Originating Call Control Element.

11. A system for performing Call Redirection/Multi-Call Destination (CR/MCD) in a communications network comprising:
a Far End switch including means for determining that a CR/MCD call leg for a subscriber cannot be established and means for communicating with a Network Element that the CR/MCD call leg cannot be established and the reason the CR/MCD call leg cannot be established;
a Detector located- remotely from the Far End Switch including means for communicating with the Far End switch to determine that the CR/MCD call leg cannot be established and the reason that the CR/MCD call leg cannot be established and means for notifying a network element that a CR/MCD call leg for the subscriber cannot be established; and
a Resolving Network Element including means for communicating with the Detector for determining that a CR/MCD call leg cannot be established and the reason that the CR/MCD call leg cannot be established and means for performing an Action based on the failure to establish the CR/MCD call leg.

12. The system defined in claim 11 wherein the Detector is an Originating Call Control Element.

13. The system defined in claim 11 wherein the Action includes notifying a subscriber/owner that a CR/MCD call leg cannot be established.

14. The system defined in claim 11 wherein the Action includes notifying a subscriber/owner of the reason that a CR/MCD call leg cannot be established.

15. The system defined in claim 11 wherein the Action includes notifying a subscriber/owner of a different destination number for establishing the failed CR/MCD call leg.

16. The system defined in claim 11 wherein the CR/MCD call leg is part of a Flexible Alerting call operation and the Action includes at least one of notifying the Flexible Alerting Pilot that a CR/MCD call leg cannot be established and notifying the Flexible Alerting Pilot of the reason that a CR/MCD call leg cannot be established.

17. The system defined in claim 11 wherein the CR/MCD call leg is part of a Simultaneous Ringing call operation.

18. The system defined in claim 11 wherein the CR/MCD call leg is part of a Multi-Line Hunt Group call operation.

19. The system defined in claim 11 wherein the CR/MCD call leg is part of a Call Forwarding call operation.

20. The method defined in claim 11 wherein the communications network includes at least one of a circuit switched network, a packet network, an Internet Protocol Multimedia Subsystem (IMS) network, and an Internet Protocol network.
